(19) United States
(12) Patent Application Publication
(10) Pub. No.: US 2018/0348421 A1
(43) Pub. Date: Dec. 6, 2018

(54) LIQUID CRYSTAL DISPLAY DEVICE

(71) Applicant: BOE TECHNOLOGY GROUP CO., LTD., Beijing (CN)

(72) Inventors: Ki Man KIM, Beijing (CN); Chulgyu JUNG, Beijing (CN)

(21) Appl. No.: 15/527,857

(22) PCT Filed: Jan. 22, 2016
(86) PCT No.: PCT/CN2016/071763

§ 371 Date: May 18, 2017

(30) Foreign Application Priority Data
Aug. 31, 2015 (CN) 201510549344.2

(51) Int. Cl. F21V 8/00; G02F 1/1335

(52) U.S. Cl. CPC G02B 6/005; G02B 6/0065; G02F 1/133621; G02F 2202/36; G02F 1/133514; G02F 2001/133614; G02B 6/0051

(57) ABSTRACT

A liquid crystal display device, including a liquid crystal panel and a backlight module located on a light incident side of the liquid crystal panel; the liquid crystal panel including a plurality of subpixels distributed in array, and the backlight module includes a light guide plate and a light source, wherein the light source which is a monochromatic light source, and a grating is provided on the light guide plate, a ratio of a period of the grating to a peak wavelength of light emitted by the light source is greater than or equal to and less than or equal to 1, so that an angle of incidence of a light incident to the liquid crystal panel is restricted in a set range; and the liquid crystal display device further includes a light conversion module provided on a light emitted side of the liquid crystal panel configured to convert the color of a light.

### TECHNICAL FIELD

Embodiments of the present disclosure relate to a liquid crystal display device.

### BACKGROUND

In conventional arts, a TN liquid crystal display device has a structure as shown in FIG. 1, in which a white light source 03 is used in a backlight module. There is a limitation on incident angle for light incident into a light guide plate 02 when the light is emitted from the light guide plate 02, but the light is still stray when being emitted from the light guide plate 02, so that no matter liquid crystal molecules 011 in a liquid crystal layer of a liquid crystal panel 01 are in an initial alignment state or in a deflected state under the action of an electric field, the angle between the light and the long axis of the liquid crystal molecules 011 in the liquid crystal layer is in a great range when the light passes through the liquid crystal layer of the liquid crystal panel 01, as a result of which the liquid crystal molecules 011 have different retardation for respective rays of light, and when the TN liquid crystal display device displays an image, it is difficult for respective pixel units to achieve a normal bright state or a normal dark state, and it is difficult to perform precise control on the color displayed by each pixel unit through controlling deflection of the liquid crystal molecules, thereby causing an image of poor quality displayed on the liquid crystal display device.

### SUMMARY

At least one embodiment of the present disclosure provides a liquid crystal display device with good display quality, in which a bright state, a dark state and colors of respective pixel units are controlled precisely.

At least one embodiment of the present disclosure provides a liquid crystal display device, which comprises a liquid crystal display panel and a backlight module positioned at a light incident side of the liquid crystal display panel, the liquid crystal display panel comprises a plurality of sub-pixels arranged in array, the backlight module comprises a light guide plate and a light source, wherein:

the light source is a monochromatic light source;

the light guide plate is provided with a grating thereon, and a ratio of a period of the grating to a peak wavelength of the light emitted from the light source is equal to or greater than 0.5 and less than or equal to 1, so that an incident angle of the light incident into the liquid crystal panel is limited within a set range; and

a light emitting side of the liquid crystal panel is provided with an optical conversion module configured to convert colors of the light emitted from the light source upon the light passing through the respective sub-pixels into respective colors to be displayed by the respective sub-pixels.

According to one embodiment of the present disclosure, the set range is greater than or equal to −15° and less than or equal to +15°.

According to one embodiment of the present disclosure, the grating is provided on a side of the light guide plate facing the liquid crystal panel, and/or,

the grating is provided on a side of the light guide plate away from the liquid crystal panel.

According to one embodiment of the present disclosure, the light guide plate is made of polymethyl methacrylate or polycarbonate.

According to one embodiment of the present disclosure, the grating and the light guide plate are made of the same material, or the grating is made of metallic material.

According to one embodiment of the present disclosure, the sub-pixels comprise red sub-pixels, green sub-pixels and blue sub-pixels, and the light source is a blue monochromatic light source.

According to one embodiment of the present disclosure, the optical conversion module provided on the liquid crystal panel comprises:

a first quantum dot light emitting layer corresponding to each of the red sub-pixels, which emits red light upon excitation of blue light; and/or

a second quantum dot light emitting layer corresponding to each of the green sub-pixels, which emits green light upon excitation of blue light.

According to one embodiment of the present disclosure, the optical conversion module provided on the liquid crystal panel further comprises:

a red filter layer provided on a side of the first quantum dot layer away from the backlight module and corresponding to the red sub-pixels; and

a green filter layer provided on a side of the second quantum dot layer away from the backlight module and corresponding to the green sub-pixels.

According to one embodiment of the present disclosure, the optical conversion module further comprises a blue filter layer corresponding to the blue sub-pixels.

According to one embodiment of the present disclosure, light scattering particles is mixed in the first quantum layer and the second quantum layer; and/or

light scattering particles are mixed in the red filter layer, the green filter layer and the blue filter layer.

In the liquid crystal display device described above, the light source used in the backlight module is a monochromatic light source. By diffraction phenomenon of light, when the ratio of the period of the grating provided on the light guide plate to the peak wavelength of the light emitted from the light source is equal to or greater than 0.5 and less than or equal to 1, the grating can provide an excellent light converging effect on the monochromatic light emitted from the monochromatic light source, and thus can limit the incident angle of the light incident into the liquid crystal panel to a set range, which makes liquid crystal molecules in a liquid crystal layer of the liquid crystal panel have small differences in phase delay for all the incident light and improves display precision in the bright state and the dark state of each pixel unit of the liquid crystal panel. Also, the optical conversion module provided on the light emitting side of the liquid crystal panel can convert the light of the sub-pixel whose color is different from the monochromatic light emitted from the light source into light matching the colors of the sub-pixels, which can improve control precision of the color displayed by the respective pixel units.

### BRIEF DESCRIPTION OF THE DRAWINGS

In order to clearly illustrate the technical solutions of the embodiments of the disclosure, the drawings of the embodiments will be briefly described in the following; it is obvious that the drawings described below are only related to some embodiments of the disclosure and thus are not limitative of the disclosure.

FIG. 1 is an illustrative structural view of a TN liquid crystal display device in the conventional arts; and

FIG. 2 is an illustrative structural view of a liquid crystal display device according to one embodiment of the present disclosure.

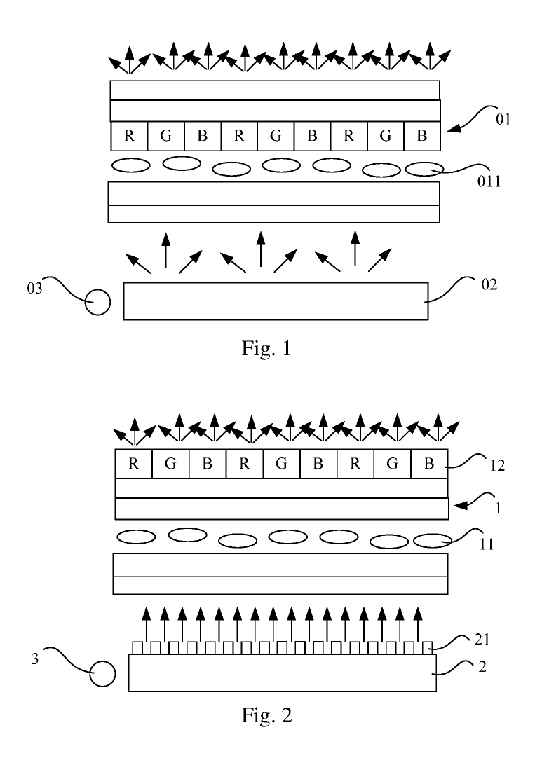

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

As illustrated in FIG. 2, one embodiment of the present disclosure provides a liquid crystal display device comprising a liquid crystal panel 1 and a backlight module disposed at a light incident side of the liquid crystal panel 1, the liquid crystal panel 1 comprising a plurality of sub-pixels arranged in array and the backlight module comprising a light guide plate 2 and a light source 3, wherein

the light source 3 is a monochromatic light source;

the light guide plate 2 is provided with a grating 21 thereon, and a ratio of a period of the grating 21 to a peak wavelength of the light emitted from the light source 3 is equal to or greater than 0.5 and less than or equal to 1, so that an incident angle of the light incident into the liquid crystal panel 1 is limited within a set range;

the liquid crystal panel 1 is provided at a light emitting side with an optical conversion module 12 configured to convert colors of the light emitted from the light source 3 upon the light passing through the respective sub-pixels into respective colors to be displayed by the respective sub-pixels.

In the above-described liquid crystal display device, the light source 3 used in the backlight module is a monochromatic light source. By diffraction phenomenon of light, when the ratio of the period of the grating 21 provided on the light guide plate 2 to the peak wavelength of the light emitted from the light source 3 is equal to or greater than 0.5 and less than or equal to 1, the grating 21 can provide an excellent light converging effect on the monochromatic light emitted from the monochromatic light source, and thus can limit the incident angle of the light incident into the liquid crystal panel 1 to a set range, which makes liquid crystal molecules 11 in a liquid crystal layer of the liquid crystal panel 1 have small differences in phase delay for all the incident light and improves display precision in the bright state and the dark state of each pixel unit of the liquid crystal panel 1. Also, the optical conversion module 12 provided on the light emitting side of the liquid crystal panel 1 can convert the light of the sub-pixel whose color is different from the monochromatic light emitted from the light source into light matching the colors of the sub-pixels, which can improve control precision of the color displayed by the respective pixel units.

When the light emitting from the light guide plate 2 is incident into the liquid crystal panel, light with a large incident angle has a reduced incident angle under the light converging effect of the grating. Therefore, the grating can limit the incident angle of the light incident into the liquid crystal panel 1 to a set range.

And, to facilitate the description of the working principle of the optical conversion module 12 in the liquid crystal panel 1, provided that the aforementioned light source 3 is a blue monochromatic light source and each pixel unit comprises a red sub-pixel, a green sub-pixel and a blue sub-pixel, the optical conversion module corresponding to the red sub-pixel can convert blue light into red light and the optical conversion module corresponding to the green sub-pixel can convert blue light into green light.

In one embodiment of the present disclosure, the set range of the incident angle is greater than or equal to −15° and less than or equal to +15°.

In one embodiment of the present disclosure, as illustrated in FIG. 2, in the light guide plate 2 provided in the backlight module of the above-described liquid crystal display device, the above-described grating 21 is provided on a side of the light guide plate 2 facing the liquid crystal panel 1, or, the grating can be provided on a side of the light guide plate 2 facing away from the liquid crystal panel 1.

Of course, the grating can be provided on both the side of the light guide plate 2 facing the liquid crystal panel 1 and the side away from the liquid crystal panel 1.

In one embodiment of the present disclosure, the aforementioned light guide plate 2 can be made of polymethyl methacrylate (PMMA), or alternatively, it can be made of polycarbonate (PC).

The aforementioned grating 21 is a grating made of reflective material. For example, the grating 21 and the light guide plate 2 can be made of the same material. Alternatively, the grating 21 can be made of metallic material and the grating 21 can be formed by depositing a metallic material directly on the light guide plate 2 and treating the metallic material through a patterning process.

In one embodiment of the present disclosure, the sub-pixels in the liquid crystal panel 1 comprise red sub-pixels, green sub-pixels and blue sub-pixels, and the light source 3 is a blue monochromatic light source.

When the above-described light source 3 is a blue monochromatic light source, for example, the optical conversion module 12 provided on the liquid crystal panel 1 can comprise:

a first quantum dot light emitting layer corresponding to the respective red sub-pixels, which emits red light upon excitation of blue light; and

a second quantum dot light emitting layer corresponding to the respective green sub-pixels, which emits green light upon excitation of blue light.

The first quantum dot light emitting layer in the optical conversion module 12 can emit red light when being excited by blue light so as to provide red light for the red sub-pixels; the second quantum dot light emitting layer can emit green light when being excited by blue light so as to provide green light for the green sub-pixels; blue light can be directly provided to the blue sub-pixels, thereby enabling color display of the liquid crystal display device.

In one embodiment of the present disclosure, to further improve purity of the colors of the light emitted by the sub-pixels of each color, the optical conversion module 12 provided in the liquid crystal panel 1 further comprises:

a red color filter layer provided on a side of the first quantum dot layer away from the backlight module and corresponding to the red sub-pixels; and/or

a green color filter layer provided on a side of the second quantum dot layer away from the backlight module and corresponding to the green sub-pixels.

The red color filter layer can filter out blue light in the light emitting from the red sub-pixels which is not completely converted, and meanwhile, the green color filter layer can filter out blue light in the light emitted from the green sub-pixels which is not completely converted, so that the color purity of the light emitted from the red sub-pixels and the green sub-pixels in the liquid crystal panel 1 by is improved and thus the display effect of the liquid crystal display device is improved.

In one embodiment of the present disclosure, the optical conversion module 12 further comprises a blue color filter layer corresponding to the blue sub-pixels.

In order to increase a scattering angle of the light exiting from the liquid crystal panel 1 and thus improve a visible viewing angle of the liquid crystal display device, in one embodiment of the present disclosure, the first quantum layer and the second quantum layer are mixed with light scattering particles; and/or

light scattering particles are mixed in the red color filter layer, the green color filter layer and the blue color filter layer.

The foregoing are merely exemplary embodiments of the disclosure, but are not used to limit the protection scope of the disclosure. The protection scope of the disclosure shall be defined by the attached claims.

The present disclosure claims priority of Chinese Patent Application No. 201510549344.2 filed on Aug. 31, 2015, the disclosure of which is hereby entirely incorporated by reference as a part of the present disclosure.

1. A liquid crystal display device comprising a liquid crystal panel and a backlight module positioned at a light incident side of the liquid crystal panel, the liquid crystal panel comprising a plurality of sub-pixels arranged in array and the backlight module comprising a light guide plate and a light source, wherein:
the light source is a monochromatic light source;
the light guide plate is provided with a grating thereon, and a ratio of a period of the grating to a peak wavelength of the light emitted from the light source is equal to or greater than 0.5 and less than or equal to 1, so that an incident angle of the light incident into the liquid crystal panel is limited within a set range; and
a light emitting side of the liquid crystal panel is provided with an optical conversion module configured to convert colors of the light emitted from the light source upon the light passing through the respective sub-pixels into respective colors to be displayed by the respective sub-pixels.

2. The liquid crystal display device according to claim 1, wherein the set range of the incident angle is greater than or equal to −15° and less than or equal to +15°.

3. The liquid crystal display device according to claim 1, being characterized in that the grating is provided on a side of the light guide plate facing the liquid crystal panel, and/or,
the grating is provided on a side of the light guide plate away from the liquid crystal panel.

4. The liquid crystal display device according to claim 1, wherein the light guide plate is made of polymethyl methacrylate or polycarbonate.

5. The liquid crystal display device according to claim 1, wherein the grating and the light guide plate are made of the same material, or the grating is made of metallic material.

6. The liquid crystal display device according to claim 1, wherein the sub-pixels comprise red sub-pixels, green sub-pixels and blue sub-pixels, and the light source is a blue monochromatic light source.

7. The liquid crystal display device according to claim 1, wherein the optical conversion module provided on the liquid crystal panel comprises:
a first quantum dot light emitting layer corresponding to each of the red sub-pixels, which emits red light upon excitation of blue light;
a second quantum dot light emitting layer corresponding to each of the green sub-pixels, which emits green light upon excitation of blue light.

8. The liquid crystal display device according to claim 7, wherein the optical conversion module provided on the liquid crystal panel further comprises:
a red filter layer provided on a side of the first quantum dot light emitting layer away from the backlight module and corresponding to the red sub-pixels; and
a green filter layer provided on a side of the second quantum dot light emitting layer away from the backlight module and corresponding to the green sub-pixels.

9. The liquid crystal display device according to claim 8, wherein the optical conversion module further comprises a blue filter layer corresponding to the blue sub-pixels.

10. The liquid crystal display device according to claim 8, wherein light scattering particles is mixed in the first quantum light emitting layer and the second quantum light emitting layer; and/or
light scattering particles are mixed in the red filter layer, the green filter layer and the blue filter layer.

11. The liquid crystal display device according to claim 2, being characterized in that the grating is provided on a side of the light guide plate facing the liquid crystal panel, and/or,
the grating is provided on a side of the light guide plate away from the liquid crystal panel.

12. The liquid crystal display device according to claim 2, wherein the light guide plate is made of polymethyl methacrylate or polycarbonate.

13. The liquid crystal display device according to claim 3, wherein the light guide plate is made of polymethyl methacrylate or polycarbonate.

14. The liquid crystal display device according to claim 2, wherein the grating and the light guide plate are made of the same material, or the grating is made of metallic material.

15. The liquid crystal display device according to claim 3, wherein the grating and the light guide plate are made of the same material, or the grating is made of metallic material.

16. The liquid crystal display device according to claim 4, wherein the grating and the light guide plate are made of the same material, or the grating is made of metallic material.

17. The liquid crystal display device according to claim 2, wherein the sub-pixels comprise red sub-pixels, green sub-pixels and blue sub-pixels, and the light source is a blue monochromatic light source.

18. The liquid crystal display device according to claim 3, wherein the sub-pixels comprise red sub-pixels, green sub-pixels and blue sub-pixels, and the light source is a blue monochromatic light source.

19. The liquid crystal display device according to claim 4, wherein the sub-pixels comprise red sub-pixels, green sub-pixels and blue sub-pixels, and the light source is a blue monochromatic light source.

20. The liquid crystal display device according to claim 5, wherein the sub-pixels comprise red sub-pixels, green sub-pixels and blue sub-pixels, and the light source is a blue monochromatic light source.
